(19) United States
(12) Patent Application Publication
(10) Pub. No.: US 2009/0263307 A1
(43) Pub. Date: Oct. 22, 2009

(54) Silicon Production Process

(75) Inventors: Leonard Nanis, San Jose, CA (US); Shi Yuan, Danville, CA (US); Matthew Sakae Forkin, San Mateo, CA (US)

Correspondence Address: Meyer Solar;Attn: Edward S. Sherman, Esq., One Meyer Plaza, Vallejo, CA, 94590, US

(73) Assignee: CIRCULON HUNGARY LTD., Budapest (HU)

(21) Appl. No.: 12/425,714

(22) Filed: Apr. 17, 2009

Related U.S. Application Data
(60) Provisional application No. 61/045,906, filed on Apr. 17, 2008.

(51) Int. Cl. C01B 33/32; C01B 33/02

(52) U.S. Cl. 423/350; 423/332; 423/333

(57) ABSTRACT

An improved process for producing high purity silicon results from the reaction of sodium with pure silicon tetrafluoride gas, which produces sodium fluoride as a by-product. The silicon tetrafluoride gas is formed by decomposing sodium fluorosilicate. The sodium fluorosilicate is produced by precipitation when fluorosilicic acid (FSA) is reacted with the by-product sodium fluoride in closed loop process. Likewise, the fluorosilicic acid is preferably formed at high purity using a source material that consists essentially of silica by reacting the by-product sodium fluoride with an acid to create reactive fluoride ions.

### CROSS REFERENCE TO RELATED APPLICATIONS

The present application claims priority to the US provisional application for “DUAL PURPOSE SILICON”, having application Ser. No. 61/045,906, which was filed on Apr. 17, 2008, and which is incorporated herein by reference.

### BACKGROUND OF INVENTION

The present invention relates to a method to make pure fluorosilicic acid (FSA) as a precursor feedstock for the production of pure silicon fluorosilicate (SFS). The invention also relates to an improved process for making metallic silicon from SFS.

When heated, the pure SFS provides pure gaseous silicon tetrafluoride for reaction with sodium metal, yielding pure silicon as a product

The rapidly growing silicon solar cell industry competes with the semiconductor industry for silicon, which is thus in short supply. The purity requirements for solar grade silicon are different from those of semiconductor grade silicon. Whereas very low levels of phosphorus (P) and boron (B) are desirable in semiconductor silicon, less pure silicon with much greater initial P and B content can be tolerated for solar grades. A known reaction sequence for producing low cost silicon starting with low cost FSA by-product from the phosphate fertilizer industry also carries over P and B to precipitated SFS and to end product silicon which thus limits use to solar cells only.

What is needed is an alternative low cost source of clean FSA with low levels of P and B to replace phosphate fertilizer by-product FSA.

It is therefore a first object of the present invention to provide to increase the supply of high purity silicon which can serve the dual purpose of meeting the purity requirements of both the semiconductor and solar industries.

It is another object of the present invention to provide an improved process for manufacturing such high purity silicon wherein reaction by-products are recycled in a substantially closed loop system.

### SUMMARY OF INVENTION

In the present invention, the first object is achieved by providing a process for synthesizing fluorosilicic acid comprising the steps of providing a source of silicon consisting essentially of silica, providing a source of fluoride ions, providing a source of sodium ions, reacting the source of silicon with the fluoride ions to form fluorosilicic acid (FSA), reacting the sodium ion with FSA to precipitate sodium fluorosilicate (SFS) and generate hydrofluoric acid, and separating the precipitated SFS from the reaction mixture of the previous step.

A second aspect of the invention is characterized by a process for synthesizing silicon comprising the steps of providing a source of silicon consisting essentially of silica, providing a source of fluoride ions, providing a source of sodium ions, reacting the source of silicon with the fluoride ions to form fluorosilicic acid (FSA), reacting the sodium ions with FSA to precipitate sodium fluorosilicate (SFS) and generate hydrofluoric acid, separating the precipitated SFS from the reaction mixture of the previous step, decomposing the SFS to generate silicon tetrafluoride gas, reacting the silicon tetrafluoride gas with sodium to produce metallic silicon and sodium fluoride.

Other aspects of the invention include re-cycling the sodium fluoride and/or hydrofluoric acid by products for reaction with the source of silicon that consists essentially of phosphorus and boron free silica.

The above and other objects, effects, features, and advantages of the present invention will become more apparent from the following description of the embodiments thereof taken in conjunction with the accompanying drawings.

### DETAILED DESCRIPTION

One aspect of the present invention is a method to make pure fluorosilicic acid (FSA) as a precursor feedstock for the production of pure silicon fluorosilicate (SFS). When heated, the pure SFS provides pure gaseous silicon tetrafluoride for reaction with sodium metal, yielding pure silicon as a product. The rapidly growing silicon solar cell industry competes with the semiconductor industry for silicon, which is thus in short supply. The purity requirements for solar grade silicon are different from those of semiconductor grade silicon. Whereas very low levels of phosphorus (P) and boron (B) are desirable in semiconductor silicon, less pure silicon with much greater initial P and B content can be tolerated for solar grades. A known reaction sequence for producing low cost silicon starting with low cost FSA by-product from the phosphate fertilizer industry also carries over P and B to precipitated SFS and to end product silicon which thus limits use to solar cells only. What is needed is an alternative low cost source of clean FSA with low levels of P and B to replace phosphate fertilizer by-product FSA. The goal of this invention is to increase the supply of high purity silicon which can serve the dual purpose of meeting the purity requirements of both the semiconductor and solar industries.

There is a plentiful supply of FSA, a by-product of phosphate fertilizer manufacture. The use of by-product FSA is the basis for several US patents, now expired, obtained by SRI International for the chemical reduction of silicon tetrafluoride by sodium (4,442,082; 4,584,181; 4,590,043; 4,597,948; 4,642,228; 4,655,827; 4,753,783 and 4,777,030), all of which are incorporated herein by reference.

Commercial grade (23 weight percent) FSA is the starting feedstock for the process steps described in paragraph [0001], as reported in FIG. 1 of the journal article entitled “Silicon by Sodium Reduction of Silicon Tetrafluoride”, J. Electrochemical Society, vol. 128 (1981) pp. 179-184, authored by SRI International researchers, which is also incorporated herein by reference.

For convenience, the process is herewith referred to as the “SRI process.” Similar flow charts are included in the above-mentioned SRI patents, as for example, FIG. 1 of U.S. Pat. No. 4,748,014, which is also incorporated herein by reference.

As starting input to the SRI process flow chart, the preferred feedstock is identified as commercial grade 23 weight percent FSA, a by-product of the phosphate fertilizer industry. In the first step of the SRI process, sodium ion is added to FSA to precipitate sodium fluorosilicate (SFS). The properly chemically balanced precipitation reaction using solid sodium fluoride (NaF) as the source of sodium ion is:

H₂SiF₆+2NaF→Na₂SiF₆+2 HF (1)

Sodium fluorosilicate, SFS, is also available commercially in the form of dry, non-hygroscopic powder, precipitated from commercial grade FSA by the addition of sodium ion in a manner similar to the first step of the SRI process, the above-written chemical equation.

Other investigators of the reactions underlying the SRI process also consider by-products of the phosphate fertilizer industry as the source of silicon. In U.S. Pat. No. 4,446,120, which is incorporated herein by reference, Schmidt et al. begin with already precipitated SFS and describe heated SFS as a source for gaseous silicon tetrafluoride for reductive reaction with sodium metal (see present Equation 2). Schmidt et al. note [col 1, lines 34-36] that “One readily available source of silicon is sodium fluorosilicate (Na₂SiF₆) which is a by-product of the phosphate fertilizer industry”.

As stated in the background section, a purpose of this invention is to obtain low cost, clean FSA (and SFS) which will avoid the P and B impurities associated with FSA by-product of the phosphate fertilizer industry.

However, the “wet-process” for phosphate fertilizer manufacture contributes phosphorous and boron as impurities to FSA and ultimately to SFS and to sodium reduced silicon. The wet process is so-named because sulfuric acid reacts with phosphate ore to yield the desired phosphoric acid and difficult to dispose by-products FSA and calcium sulfate (gypsum). The present invention recognizes that the chemistry of the side reactions that yield by-product liquid FSA and solid gypsum may be isolated and harnessed so as to produce clean FSA and thus clean SFS and silicon.

The present invention uses naturally occurring pure silicon dioxide (silica) as a low cost source of FSA. Pure silica is abundant and is less expensive per weight of contained silicon than commercially available FSA. The key ingredients to produce clean FSA are the combination of silica, an acid, preferably sulfuric acid, and a source of fluoride ion, preferably calcium fluoride (fluorite) or more preferably sodium fluoride. By-product sodium fluoride from the sodium metal reduction of silicon tetrafluoride (Equation 3) can provide a recycled source of sodium fluoride. Conversion steps of FSA to SFS to silicon will be able to avoid phosphorus and boron and other impurities associated with phosphate by-product FSA. The purity of silicon produced starting with the FSA of this invention may qualify it for dual purpose use—both for semiconductor devices and solar cells.

### BACKGROUND

It is attractive to consider the ecological benefit of obtaining silicon from the waste material generated from the phosphate fertilizer industry. In addition, the cost per kilogram of contained silicon is remarkably low when waste fluorosilicic acid, FSA, serves as the source. While fluorosilicic acid derived from the fertilizer process is an admirable source on an ecological basis and also a cost basis, impurities are present because of the very nature of the source material. These impurities can be tolerated in the conventional uses for FSA such as an additive to fluoridate municipal water supplies and in ceramics technology. However, for silicon produced with FSA as a starting feedstock, seemingly minor amounts of certain impurities are detrimental to performance in solar cells and also semiconductors.

In brief, silicon obtained from waste by-product FSA contains a high proportion of the elements boron, B, and phosphorus, P. Both B and P are active ingredients diffused purposely into silicon wafers (doping) in the fabrication of solar cells. For example, P is frequently diffused into silicon to define the n-p junction, typically to a depth of about 4000 Angstrom. The requirements for low background B and P concentration levels in semiconductor structures are more stringent than for solar applications. For semiconductors, a low initial level of impurity B and P is desirable as a convenient reference starting point for controlled process doping additions.

When by-product commercial grade FSA is the feedstock, the elements B and P transfer to precipitated sodium fluorosilicate (SFS). The mechanism of transfer from FSA to SFS and then to silicon has not been studied in any great detail.

A goal of the present invention is to develop a simple means to get the P and B out of the silicon in order to have dual purpose material for both photovoltaies and semiconductor wafer fabrication. Methods have been suggested in the literature for purifying commercial FSA such as the use of membranes. However, the present invention is a simple and straightforward method to reduce B and P content by completely avoiding these elements at the very front end of processing.

The present invention provides a novel path to get clean FSA by modifying and controlling the secondary chemical reactions that generate FSA as a phosphate fertilizer by-product. Instead of phosphate rock, the starting material for the present invention is clean, low cost silica as the primary source of silicon. Better control of the FSA producing reactions is obtained by starting with a defined amount of silica and fluoride ion rather than depend on the highly variable content of siliceous material in phosphate rock ore. Additionally, the present invention permits improved control of the reaction rate by pre-selection of the particle size of pure silica and also of solid fluoride compound added to provide the fluoride ion required for the formation of FSA by acid digestion of silica according to Eqn 2B. Fluoride ion for silica digestion may also be obtained from the solution of NaF resulting from aqueous leaching used to separate the mixture of solid NaF and Si produced by the Na—SiF₄ reaction Eqn 4.

### Source Chemistry

It is helpful to briefly consider the mineralogy and chemistry of phosphate rock mining as background for the present invention for obtaining extra pure FSA and SFS. The key ingredient in phosphate fertilizer ore is the mineral “apatite”, also known as “fluoroapatite”, which is calcium fluorophosphate with the chemical formula:

Ca₅(PO₄)₃F

Note that silicon is not part of the apatite crystal structure. The silicon is in a different rock, principally silicates and silicon dioxide (quartz) which just happens to be naturally mixed in with the phosphate-bearing rock. In addition to the minerals quartz and apatite, the ore may also contain calcium carbonate, CaCO₃, the mineral “calcite.”

In the “wet process” of phosphate fertilizer production, two reactions occur simultaneously when sulfuric acid is added to apatite in the ore. The first reaction is shown in Eqn 2A, the second in Eqn 2B.

Ca₅(PO₄)₃F+5H₂SO₄→3H₃PO₄+5CaSO₄+(H⁺)+(F⁻) (2A)

SiO₂+6H⁺+6F⁻→H₂SiF₆+2H₂O (2B)

As apatite mineral is attacked by sulfuric acid (Eqn 2A), the fluorine component of the apatite of the mineral is solubilized into the aqueous acid solution as fluoride ion. Eqn 2A is a plausible overall chemical sequence useful for the purpose of material balance calculations although it is understood that the overall chemistry may be composed of several intermediate reaction steps. It is postulated that the fluoride ion released from the apatite and some of the hydrogen ion from the sulfuric acid temporarily associate in solution, providing a chemical activity equivalent to hydrofluoric acid (HF). The acidified fluoride ion immediately proceeds to attack any silica present to form the by-product FSA according to the reaction in Eqn 2B. The reaction between sulfuric acid and apatite forms phosphoric acid (the desired fertilizer product) and also by-product calcium sulfate CaSO₄ (gypsum).

While sulfuric acid is the source of hydrogen ions conventionally used in phosphate processing, the hydrogen ion can come from other acids as well.

If there were no silica in the ore, there would be no unwanted by-product FSA from the “wet-process” acid digestion of apatite-bearing phosphate fertilizer ore. The present invention focuses on silica as the main constituent for chemical reaction according to Eqn 2B, essentially completely removing any source of phosphorus. The fluorine no longer available from apatite is provided separately through fluoride compounds added to the reaction in amounts calculated to effectively match the mass of silica being treated. The balancing of reaction chemistry will desirably provide for close control of the Eqn 2B reaction.

As stated, the present invention is to purposely make FSA as a primary reaction product without getting involved with phosphate ore chemistry. Carefully selected silica will serve as the source of silicon and a selected fluoride compound will provide fluorine for H₂SiF₆ (FSA). Purity will be maintained in the subsequent reaction to form a precipitate of SFS by the use of selected pure sources of sodium ion. Recycled by-product sodium fluoride (NaF) from the reaction of Eqn 4, that is the process of using the SFS to generate (SiCl4) SiF₄ for reaction with liquid sodium to produce Silicon metal and sodium fluoride (NaF), will preferably serve as a suitable source in preference to the NaF residue of SFS thermal decomposition (Eqn 3) which will retain any non-volatile impurities.

### Impurities

The main impurities of concern for semiconductor applications are B and P. Typical concentrations of B and P in SFS have been reported by Chiotti (The Pseudobinary System NaF—Na₂SiF₆, J. Less Common Metals, v.80 (1981) pp. 105-113. Chiotti analyzed two commercial sources of SFS by inductively coupled plasma spectroscopy and found 3120 parts per million by weight (ppmwt) of B in a sample from the first source and 65 ppmwt B from the second source. The first sample also had 3000 ppmwt P, while the second source sample had 2050 ppmwt P. Chiotti also reported aluminum as a major impurity in commercial grade SFS with 1250 ppmwt A1 in the first source sample and 930 ppmwt in the second source sample. It is noted that aluminum is also a frequently used dopant for silicon in semiconductor technology.

An advantage of using the thermal decomposition of SFS (Eqn 3) to provide silicon tetrafluoride as the silicon-containing reactant for reaction with sodium (Eqn 4) is that non-volatile impurity compounds remain in the NaF residue and do not transfer over into the reactor. However, some B and P is known to transfer to the silicon produced by reaction between sodium and silicon tetrafluoride (Eqn 4) following generation of SiF₄ from thermal decomposition of SFS (Eqn 3).

Na₂SiF₆→SiF₄+2NaF (3)

4Na+SiF₄→Si+4NaF (4)

An indication of the amount of B and P that can be transferred to Si in the sodium reaction (Eqn 4) (as reported by the SRI group. J. Electrochem Soc.v 128, 1981 p 179) is shown in Table 1, together with data determined by Chiotti for commercially prepared SFS.

While relatively high levels of B and P may be tolerable for photovoltaic silicon, it is instructive to compare them in Table 1 with the B and P levels customarily encountered in “pure” silicon used for semiconductor device processing. Table 1 also includes concentrations of B and P in SFS precipitated from commercial grade FSA, as reported by SRI, supra.

TABLE 1
Boron and Phosphorus Concentrations, parts per million (by weight)

| Source | Boron | Phosphorus |
|---|---|---|
| Commercial SFS #1(Chiotti) | 3120 | 3000 |
| Commercial SFS #2(Chiotti) | 65 | 2050 |
| SRI SFS precipitated by adding NaF to | 0.6 | 5 |
| commercial FSA | | |
| SRI silicon, from Na reacted with SiF₄, Eqn 4 | 0.1 | 0.2 |
| Low impurity semiconductor Si (10 to the 14th | 0.0008 | 0.002 |
| atoms per cc) | | |

There are major differences shown in Table 1 for impurity levels in commercial SFS (Chiotti) as compared with SFS precipitated by SRI from commercial grade FSA. In addition, the concentrations of B and P reported by SRI in silicon produced by reaction of sodium with SiF₄ (Eqn 4) are well above the levels in semiconductor grade silicon. For the purpose of comparison, Table 1 lists ppmwt for dopant concentration, converted from number of atoms per cubic centimeter, the units preferred by the semiconductor industry.

For semiconductor grade silicon at the start of wafer processing, i.e. before B and P doping, impurity levels are typically as low as 10 to the 13th or 14th (10¹³ or 10¹⁴) atoms per cubic centimeter. Highly refined float zone silicon can have as little as 10 to the 11th (10¹¹) atoms per cc of boron. For the phosphorus example shown in Table 1, 10 to the 14th (10¹⁴) atoms per cubic centimeter is the equivalent of 0.002 parts per million by weight, clearly well below the P levels in silicon produced by the reaction in Eqn 4, as reported by SRI.

Silica as the Source Of FSA and SFS

As mentioned, the present invention will minimize P and B impurity levels in the final silicon product by making clean FSA and SFS. The straightforward approach of generating freshly made FSA starts with pure silica as feedstock. Pure silica with 99.7 weight percent or better SiO₂ is commercially available in several forms and is in abundance throughout the world.

Silica is reacted with an acid, such as hydrofluoric acid or sulfuric acid plus NaF to form a source of fluoride ions that react with the silica to form several by-products that can be used or purified to form Silicon Tetrafluoride (STF). When the acid is sulfuric acid (H₂SO₄) there are three reaction pathways possible, Eqns 5-7. The approximate yields for the fluorine compound products discussed below are based on typical yields experienced for similar reactions in the industrial production of SFS.

SiO₂+H₂SO₄+4NaF→SiF_{4(g)}+2Na₂SO₄+2H₂O (5)

SiO₂+2H₂SO₄+6NaF→Na₂SiF₆+2Na₂SO₄+2H₂O (6)

SiO₂+3H₂SO₄+6NaF→H₂SiF₆+3Na₂SO₄+2H₂O (7)

The silicon tetrafluoride gas liberated in Eqn 5 might represent only about 15% to 25% of the fluorine from the NaF starting component, with the SFS produced in Eqn 6 might represent about 40-50% of the fluorine from the NaF starting component. The silicon tetrafluoride gas can be used directly to produce silicon if sufficiently pure, or reacted further to produce SFS by first reacting with water to form FSA as:

SiF_{4(g)}+2H₂O→2H₂SiF₆+SiO₂, (8)

and then precipitating SFS from the FSA as in Eqn 1, or in saturated sodium chloride to form SFS and HCl, as:

H₂SiF₆+2NaCl→Na₂SiF₆+2HCl (9)

Likewise, the FSA formed in Eqn 7 can be converted to SFS as in Eqn 9. Eqn 7 might account for about 35%-45% of fluorine available in the starting compound.

It should be apparent that SFS can be derived from any of the three reactions in Eqns 5, 6 and 7.

It is most preferable from an economic standpoint to derive the SFS from all of these reaction, but may be less than practical depending on the actual yield in production and the difficult in separating out the by product acid salts, such as sodium sulfate in the above examples.

It should be noted that although the above compounds and routes are preferred, the sodium salts may be replaced by other alkali earth metal salts such as calcium for a non-limiting example.

There are many grades of silica that may be suitable for reaction according to Eqn 2B, ranging from finely divided silica “flour” to clean quartz sand used in glass production. While the present invention offers a path to produce a dual purpose solar-semiconductor Si with B and P at low levels, some silica sources almost certainly include other impurities such as titanium and iron that are known to be undesirable for photovoltaic use. Trace amounts of impurity elements with multiple valence states reduce solar cell efficiency by trapping the electrons produced by solar photons. Silica as a source for dual use silicon can be selected to have minimal traces of any undesirable impurity elements.

As an example of typical impurity levels in silica, the unground silica sand grade supplied by U.S. Silica Corp. as #1 DRY has particles with more than 80 percent in the size range from 0.2 to 0.3 mm. Chemical analysis indicates 99.7 weight percent SiO₂ with Fe₂O₃ at 0.024 weight percent (wt %), Al₂O₃ at 0.07 wt % and TiO₂ at 0.01 wt %. Other elements reported as oxides at or below 0.01 wt % include calcium, magnesium, sodium and potassium. Any impurity elements carried over into the granular silicon produced by reaction of SiF₄ with Na (Eqn 4) will have an opportunity for additional removal during the growth of large ingots by the refining provided typically by the Czochralski (Cz) ingot growth method.

It is of interest to note that silica serves as the feedstock for “pure” silicon made by purification of metallurgical grade silicon (abbreviated as mgSi). Metallurgical grade silicon is made by carbothermic reduction of a mixture of carbon and silica in a high temperature furnace. However, mgSi has a relatively low purity, typically 97 weight percent Si. Refining treatment is required to improve the purity of mgSi. High temperature mgSi production and purification require a substantial energy input. By comparison, the present invention involves low temperature aqueous reactions at or near room temperature in tanks constructed of relatively low cost materials.

FSA generation takes place in an aqueous mixture of acid, silica and fluoride. Likewise, precipitation of SFS by adding sodium ion to FSA takes place in an aqueous medium. Low temperature processing minimizes the opportunity for impurity transfer to the product which can occur in high temperature operations. It is also noted that the Na—SiF₄ reaction (Eqn 4) is exothermic and provides its own heat as reaction proceeds. The present invention contributes to energy savings as well as the opportunity to obtain high purity starting materials FSA and SFS for the production of pure silicon.

Cost Comparison: FSA from Silica vs. Commercial FSA

Since FSA is the starting point for precipitation of SFS and sodium reduction of gaseous SiF₄, an equivalent way to evaluate silica as a silicon source is to compare the present cost of commercial FSA (and SFS) with the raw material cost for producing fluorosilicic acid by the method of the present invention. This is not an exact comparison because process costs and profit margin are included in the price of commercial FSA and SFS and not in the present cost calculations which are based on materials only. However, reactant costs permit the calculation of a minimum base line cost to produce clean FSA.

Table 2 shows the cost benefit for using silica as silicon source by comparing the amount of silicon available from various sources and the associated cost per kilogram of available silicon. Other reagent costs are also included to obtain an overall estimate for the pure silica approach of the present invention.

TABLE 2

| | Price | | Price, raw |
|---|---|---|---|
| | Dollars/kg | percent | material Dollars |
| Source Material | raw material | Silicon | for 1 kg Si |
| Sodium Fluorosilicate | 0.85 | 14.89 | 5.71 |
| commercial SFS | | | |
| Fluorosilicic Acid, | 0.882 | 19.44 | 4.54 |
| commercial FSA 100% | | | |
| basis | | | |
| Glass sand, (Silica, SiO₂) | 0.043 | 46.7 | 0.092 |
| Filler sand, (Silica, SiO₂) | 0.126 | 46.7 | 0.270 |
| Industrial sand, (Silica, SiO₂) | 0.023 | 46.7 | 0.047 |
| US Silica #1Dry, (SiO₂) | 0.023 | 46.7 | 0.049 |
| Sulfuric acid (100% basis) per | 0.0605 | — | 0.635 |
| Eqn 2B | | | |
| Calcium fluoride (commercial | 0.242 | — | 2.022 |
| acid grade fluorspar) | | | |

Sources of silicon that consist essentially of silica include, without limitation, glass sand, filler sand, industrial sand, diatomaceous earth, recycled ground glass and the like. From Table 2, it is clear that silica is literally dirt cheap as a source of silicon on the basis of the cost of silica sufficient to yield 1 kg of silicon. As mentioned, the present invention does not need apatite as a source of fluoride ion for the reactions described in Eqns 2A and 2B. The chemistry of Eqn 2A is simplified by substituting a selected source of fluoride ion in the form of a readily soluble compound with no phosphorous content.

For the purpose of calculation based on Equation 2B, fluorspar (CaF₂) is designated as the source of fluoride ions. Acid grade fluorspar is 97% CaF₂ and costs $220 per ton (2006 price). The amount of CaF₂ needed is 232.4 kg-mol for 28 kg-mol of silicon or 144 kg-mol of 100% FSA. Since 4.9 kg of H₂SO₄ are needed for each kg of SiO₂ according to Equation 2B, the cost of sulfuric acid is $0.635 per kilogram of Si and the cost of fluorspar is $2.022 per kilogram of Si.

Adding the cost of sulfuric acid and calcium fluoride to react with silica, the total cost is $2.706 for one kilogram of Si when silica is US Silica Corp. #1Dry. The major cost item is the fluorspar, followed by sulfuric acid, with silica at less than 2% of material costs. The calculated $2.706 per kg Si is about half the cost of either commercial FSA or SFS on a comparable basis as a source for 1 kg Si.

Fluorspar is considered as the fluorine source only as an example. In more preferred embodiments of the invention the sodium fluoride by-product from the Na—SiF₄ reaction (Eqn 4) is recycled to serve as the fluorine source in the Eqn 2B silica digestion reaction. This embodiment provides the potential for a substantially closed loop manufacturing process where the re-cycling of such by-products reduces costs and the need for shipment of the by-product to other users. Likewise, HF produced in Eqn 1 can be re-cycled and used in Eqn 2B. The full assessment of integrated plant material flow will consider total mass balance and the cost of makeup NaF, if required. However, as a limiting case, if zero cost is assigned to recycled NaF fed to Eqn 2B, the total cost per kilogram Si drops to the cost of sulfuric acid ($0.635/kg Si) and silica sand ($0.049/kg Si for US Silica #1 Dry) or to a total minimum feed material cost of only $0.684/kg Si, roughly only 10 to 15 percent of the cost of either commercial FSA or SFS.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. A process for synthesizing an alkali earth metal fluorosilicate salt (AEMFS), the process comprising the steps of:
a) providing a source of silicon consisting essentially of silica,
b) providing a source of fluoride ions,
c) providing a source of alkali earth metal ions,
d) reacting the source of silicon with the fluoride ions to form fluorosilicic acid (FSA), silicon tetrafluoride and the alkali earth metal fluorosilicate salt (AEMFS),
e) separating at least the AEMFS from the reaction products.

2. A process according to claim 1 wherein the alkali earth metal ion is the sodium ion.

3. A process according to claim 2 further comprising the steps of:
a) reacting FSA with a salt of sodium to precipitate sodium fluorosilicate (SFS), and
b) separating the precipitated SFS from the reaction mixture of the previous step.

4. A process according to claim 3 further comprising the steps of:
a) capturing the silicon tetrafluoride,
b) reacting the silicon tetrafluoride with water to form FSA,
c) reacting FSA with sodium chloride to precipitate sodium fluorosilicate (SFS) and generate hydrochloric acid, and
d) separating the precipitated SFS from the reaction mixture of the previous step.

5. A process according to claim 4 wherein the salt of sodium to precipitate sodium fluorosilicate (SFS) is sodium fluoride and the source of fluoride ions is the hydrofluoric acid formed in this step.

6. A process for synthesizing fluorosilicic acid according to claim 1 further comprising the step of adding a fluoride salt to sulfuric acid to form the source of fluoride ions.

7. A process for synthesizing fluorosilicic acid according to claim 6 wherein the fluoride salt is sodium fluoride.

8. A process for synthesizing fluorosilicic acid according to claim 6 wherein the fluoride salt is calcium fluoride.

9. A process for synthesizing fluorosilicic acid according to claim 1 where the silica is selected from the group consisting of glass sand, filler sand, industrial sand, diatomaceous earth and recycled ground glass.

10. A process for synthesizing fluorosilicic acid according to claim 1 where the silica is essentially free of phosphorus and boron.

11. A process for synthesizing silicon, the process comprising the steps of:
a) providing a source of silicon consisting essentially of silica,
b) providing a source of fluoride ions,
c) providing a source of alkali earth metal ions,
d) reacting the source of silicon with the fluoride ions to form fluorosilicic acid (FSA), silicon tetrafluoride and an alkali earth metal fluorosilicate salt (AEMFS),
e) separating at least the AEMFS from the reaction products,
f) decomposing the AEMFS to generate silicon tetrafluoride gas,
g) reacting the silicon tetrafluoride gas with sodium to produce metallic silicon and the alkali earth metal salt of fluorine.

12. A process for synthesizing silicon according to claim 11 wherein the alkali earth metal is sodium.

13. A process for synthesizing silicon according to claim 12 further comprising the step of recovering the sodium fluoride salt generated in the step of producing metallic silicon to provide the source of fluoride ions.

14. A process for synthesizing silicon according to claim 12 further comprising the step of reacting sodium fluoride with FSA to precipitate sodium fluorosilicate (SFS) where the source of fluoride ions is the hydrofluoric acid formed in said step.

15. A process for synthesizing silicon according to claim 11 further comprising the step of adding a fluoride salt to sulfuric acid to form the source of fluoride ions.

16. A process for synthesizing silicon according to claim 15 wherein the fluoride salt is sodium fluoride.

17. A process for synthesizing silicon according to claim 11 where the silica is selected from the group consisting of glass sand, filler sand, industrial sand, diatomaceous earth and recycled ground glass.

18. A process for synthesizing silicon according to claim 11 where the silica is essentially free of phosphorus and boron.

19. A process for synthesizing silicon, the process comprising the steps of:
a) providing a source of silicon consisting essentially of silica,
b) providing a source of fluoride ions,
c) providing a source of sodium ions,
d) reacting the source of silicon with the fluoride ions to form fluorosilicic acid (FSA), silicon tetrafluoride and sodium fluorosilicate (SFS).
e) separating at least the SFS from the reaction products,
f) decomposing the SFS to generate silicon tetrafluoride gas,
g) reacting the silicon tetrafluoride gas with sodium to produce metallic silicon and sodium fluoride.

20. A process for synthesizing silicon according to claim 19 further comprising the step of recovering the sodium fluoride salt generated in the step of producing metallic silicon to provide the sources of sodium ions and fluoride ions.

21. A process for synthesizing silicon according to claim 19 further comprising the steps of:
a) separating at least one of the fluorosilicic acid (FSA) and silicon tetrafluoride,
b) further reacting at least one of the fluorosilicic acid (FSA) and silicon tetrafluoride to form the SFS that is decomposed to provide additional silicon tetrafluoride for said step of reaction with the sodium.

22. A process for synthesizing silicon according to claim 19 wherein sodium fluoride is reacted with the FSA to form hydrofluoric acid and the hydrofluoric acid formed in this step is further used as the source of fluoride ions in the step of providing a source of fluoride ions.

23. A process for synthesizing silicon according to claim 19 where the silica is selected from the group consisting of glass sand, filler sand, industrial sand, diatomaceous earth and recycled ground glass.

24. A process for synthesizing silicon according to claim 19 where the silica is essentially free of phosphorus and boron.
